(19) United States
(12) Patent Application Publication
(10) Pub. No.: US 2024/0026181 A1
(43) Pub. Date: Jan. 25, 2024

(54) INK SET AND INKJET RECORDING METHOD

(71) Applicant: KYOCERA Document Solutions Inc., Osaka (JP)

(72) Inventor: Daichi FUNAKOSHI, Osaka-shi (JP)

(73) Assignee: KYOCERA Document Solutions Inc., Osaka (JP)

(21) Appl. No.: 18/349,402

(22) Filed: Jul. 10, 2023

(30) Foreign Application Priority Data
Jul. 25, 2022 (JP) 2022-118125

(51) Int. Cl. C09D 11/54; C09D 11/322; C09D 11/102; B41M 5/00; C09D 11/104; C09D 11/107

(52) U.S. Cl. CPC C09D 11/54; C09D 11/322; C09D 11/102; B41M 5/0017; C09D 11/104; C09D 11/107

(57) ABSTRACT

An ink set includes an inkjet ink and a pretreatment liquid. The inkjet ink contains a pigment, anionic urethane resin particles, and an aqueous medium. The pretreatment liquid contains nonionic urethane resin particles, (meth)acrylic resin particles, and polyester resin particles.

### INCORPORATION BY REFERENCE

The present application claims priority under 35 U.S.C. § 119 to Japanese Patent Application No. 2022-118125, filed on Jul. 25, 2022. The contents of this application are incorporated herein by reference in their entirety.

### BACKGROUND

The present disclosure relates to an ink set and an inkjet recording method.

Some inkjet recording apparatus uses a water-based inkjet ink containing a pigment and an aqueous medium. The inkjet recording apparatus forms an image on a non-permeable recording medium such as a biaxially oriented polypropylene (OPP) film in some cases.

When an image is formed on a non-permeable recording medium using the inkjet recording apparatus, an inkjet ink may be repelled by the recording medium to cause a void defect on the image. Also, the image formed on the non-permeable recording medium using the inkjet recording apparatus tends to have low adhesion to the recording medium with a result that the image may peel off from the recording medium upon being rubbed by another member. In view of the foregoing, an inkjet ink used for a purpose such as above is demanded, even when forming an image on a non-permeable recording medium, to be able to form an image with excellent adhesion to the recording medium while ensuring adequate wet spreadability.

In order to meet such a demand, an ink set is proposed that includes for example an inkjet ink containing a pigment, an organic solvent, water, and a silicone surfactant and a pretreatment liquid containing a water-insoluble resin fine particles and a pigment coagulant. The ink set is said to be able to form images with excellent adhesion to a recording medium.

### SUMMARY

An ink set according to an aspect of the present disclosure includes an inkjet ink and a pretreatment liquid. The inkjet ink contains a pigment, anionic urethane resin particles, and an aqueous medium. The pretreatment liquid contains nonionic urethane resin particles, (meth)acrylic resin particles, and polyester resin particles.

An inkjet recording method according to another aspect of the present disclosure is an inkjet recording method for forming an image on a recording medium with the ink set. The method includes: applying the pretreatment liquid to the recording medium; and forming the image by ejecting the inkjet ink toward the recording medium using a head after the applying.

### DETAILED DESCRIPTION

The following describes an embodiment of the present disclosure. In the following, measurement values for volume median diameter (D₅₀) are values as measured using a dynamic light scattering type particle size distribution analyzer (e.g., “ZETASIZER (registered Japanese trademark) NANO ZS”, product of Malvern Instruments Ltd.) unless otherwise stated.

In the present specification, the term “(meth)acryl” is used as a generic term for both acryl and methacryl. For each component indicated in the present specification, one type of the component may be used independently, or two or more types of the component may be used in combination.

### First Embodiment: Ink Set

The following describes an ink set according to a first embodiment of the present disclosure. The ink set of the present disclosure includes an inkjet ink (also referred to below simply as ink) and a pretreatment liquid. The ink contains a pigment, anionic urethane resin particles, and an aqueous medium. The pretreatment liquid contains nonionic urethane resin particles, (meth)acrylic resin particles, and polyester resin particles.

The ink set of the present disclosure is suitable for image formation on a non-permeable recording medium. An ink is less penetrable through the non-permeable recording medium than through a permeable recording medium. An aqueous medium has an absorption in the non-permeable recording medium of no greater than 1.0 g/m², for example. Examples of the non-permeable recording medium include resin-made recording mediums, metal-made recording mediums, and glass-made recording mediums. Examples of the resin-made recording mediums includes a resin sheet and a resin film. The resin contained in the resin-made recording mediums is preferably a thermoplastic resin. Specific examples of the resin include polyethylene, polypropylene, polyvinyl chloride, and polyethylene terephthalate (PET). Examples of the resin-made recording mediums include an OPP film. In image formation on a resin-made recording medium with the ink set of the present disclosure, the recording medium may have a surface (printing surface) subjected to corona discharge treatment.

As a result of the ink set of the present disclosure having the above features, an image with excellent adhesion to a recording medium can be formed with the ink set with adequate ink wet spreadability ensured. The reason thereof can be inferred as follows. The pretreatment liquid of the ink set of the present disclosure contains nonionic urethane resin particles, (meth)acrylic resin particles, and polyester resin particles. The pretreatment liquid applied to a recording medium forms a film (pretreatment coating film) that mainly contains three types of resin particles. Here, the non-permeable recording medium often contains a non-polar material as a main component as typified by OPP films. By contrast, the pretreatment coating film that contains nonionic urethane resin particles, which are non-polar resin particles, has high affinity with the non-polar material. Furthermore, the (meth)acrylic resin particles optimize affinity between the pretreatment coating film and the non-polar material. As a result, the pretreatment coating film has excellent adhesion (base material adhesion) to the recording medium.

Furthermore, the pigment components (e.g., the pigment and a later-described pigment coating resin) contained in the ink is hydrophilic. By contrast, the pretreatment coating film contains (meth)acrylic resin particles and polyester resin particles, both of which are also hydrophilic resin particles. The surface of the pretreatment coating film can accordingly have adequate hydrophilicity. Therefore, the pretreatment coating film has high affinity with the pigment components. In particular, the (meth)acrylic resin particles contained in the pretreatment coating film optimize affinity between the pigment components and the pretreatment coating film. Furthermore, the ink contains anionic urethane resin particles. The anionic urethane resin particles function as binder resin particles for protecting the pigment components after image formation with the ink. Having a polarity, the anionic urethane resin particles can have high affinity with the pretreatment coating film. From the above, the ink set of the present disclosure can exhibit excellent adhesion (coating film adhesion) between the pretreatment coating film and an image formed with the ink. As such, images formed with the ink set of the present disclosure can exhibit excellent base material adhesion and coating film adhesion. This means excellent adhesion of the images to the recording medium.

Furthermore, the ink tends to adequately spread over the surface of the pretreatment coating film containing polyester resin particles. Therefore, adequate ink wet spreadability can be ensured in the ink set of the present disclosure. Note that when binder resin particles are added to a known ink, each component of the ink may readily agglomerate. By contrast, in the ink set of the present disclosure, anionic urethane resin particles are used as the binder resin particles. Here, the pigment components contained in an ink are usually anionic. Therefore, the anionic urethane resin particles cause electrostatic repulsion to the pigment components in the ink to inhibit occurrence of agglomeration as above. Thus, the ink set of the present disclosure can exhibit adequate wet spreadability of the aforementioned ink and excellent adhesion of a formed image to a recording medium while inhibiting occurrence of agglomeration of the ink.

### [Ink]

The ink included in the ink set of the present disclosure contains a pigment, anionic urethane resin particles, and an aqueous medium. Preferably, the ink further contains a pigment coating resin.

### (Pigment)

The pigment in the ink constitutes pigment particles together with the pigment coating resin, for example. The pigment particles are each constituted by a core containing the pigment and a pigment coating resin covering the core. The pigment coating resin is present in a dispersed state in a solvent, for example. In terms of optimizing color density, hue, or stability of the ink, the pigment particles have a volume median diameter of preferably at least 30 nm and no greater than 200 nm, and more preferably at least 70 nm and no greater than 130 nm.

Examples of the pigment include yellow pigments, orange pigments, red pigments, blue pigments, violet pigments, and black pigments. Examples of the yellow pigments include C.I. Pigment Yellow (74, 93, 95, 109, 110, 120, 128, 138, 139, 151, 154, 155, 173, 180, 185, or 193). Examples of the orange pigments include C.I. Pigment Orange (34, 36, 43, 61, 63, or 71). Examples of the red pigments include C.I. Pigment Red (122 or 202). Examples of the blue pigments include C.I. Pigment Blue (15, specifically 15:3). Examples of the violet pigments include C.I. Pigment Violet (19, 23, or 33). Examples of the black pigments include C.I. Pigment Black (7).

The pigment in the ink has a percentage content of preferably at least 0.5% by mass and no greater than 10.0% by mass, and more preferably at least 1.5% by mass and no greater than 5.0% by mass. As a result of the percentage content of the pigment being set to at least 0.5% by mass, the ink can form images with desired image density. As a result of the percentage content of the pigment being set to no greater than 10.0% by mass by contrast, fluidity of the ink can be ensured.

### (Pigment Coating Resin)

The pigment coating resin is a resin soluble in the aqueous medium of the ink. A portion of the pigment coating resin is present for example on the surface of the pigment particles to optimize pigment particle dispersibility. Another portion of the pigment coating resin is present for example in a dissolved state in the aqueous medium of the ink.

The pigment coating resin is preferably a styrene-(meth)acrylic resin. The styrene-(meth)acrylic resin includes a styrene unit and a repeating unit derived from at least one monomer of (meth)acrylic acid alkyl ester and (meth)acrylic acid. Examples of the (meth)acrylic acid alkyl ester include methyl (meth)acrylate, ethyl (meth)acrylate, propyl (meth)acrylate, and butyl (meth)acrylate. The styrene-(meth)acrylic resin is preferably a copolymer of styrene, methyl methacrylate, methacrylic acid, and butyl acrylate.

The pigment coating resin has a percentage content in the ink of preferably at least 0.1% by mass and no greater than 4.0% by mass, and more preferably at least 0.5% by mass and no greater than 1.5% by mass. As a result of the percentage content of the pigment coating resin being set to at least 0.1% by mass and no greater than 4.0% by mass, ejection stability of the ink can be ensured.

The pigment coating resin has a content ratio of preferably at least 10 parts by mass and no greater than 60 parts by mass to 100 parts by mass of the pigment in the ink, and more preferably at least 20 parts by mass and no greater than 30 parts by mass. As a result of the content ratio of the pigment coating resin being set to at least 10 parts by mass and no greater than 60 parts by mass, ejection stability of the ink can be optimized.

### (Anionic Urethane Resin Particles)

The anionic urethane resin particles contain an anionic urethane resin. The anionic urethane resin has a percentage content in the anionic urethane resin particles of preferably at least 80% by mass, more preferably at least 90% by mass, and further preferably 100% by mass. The anionic urethane resin is an anionic resin among urethane resins. Anionic urethane resin particles are anionic and therefore can easily coexist in an ink with pigment components that are also typically anionic.

The anionic urethane resin particles has a volume median diameter of preferably at least 5 nm and no greater than 150 nm, and more preferably at least 30 nm and no greater than 70 nm. As a result of the volume median diameter of the anionic urethane resin particles being set to at least 5 nm, preservation stability of the ink can be optimized. As a result of the volume median diameter of the anionic urethane resin particles being set to no greater than 150 nm, ejection stability of the ink can be optimized.

The anionic urethane resin particles has a percentage content in the ink of preferably at least 1.0% by mass and no greater than 12.0% by mass, and more preferably at least 2.0% by mass and no greater than 6.0% by mass. As a result of the percentage content of the anionic urethane resin particles being set to at least 1.0% by mass, adhesion of an image formed with the ink set of the present disclosure to a recording medium can be further optimized. As a result of the percentage content of the anionic urethane resin particles being set to no greater than 12.0% by mass, ejection stability of the ink can be optimized.

### (Urethane Resins)

The urethane resins are copolymers of a monomer containing polyisocyanate and a diol compound or a bisphenol compound.

An example of the polyisocyanate is diisocyanate. Examples of the diisocyanate include aliphatic diisocyanates, alicyclic diisocyanates, and aromatic diisocyanates.

Examples of the aliphatic diisocyanates include ethylene diisocyanate, 2,2,4-trimethylhexamethylene diisocyanate, and 1,6-hexamethylene diisocyanate.

Examples of the alicyclic diisocyanates include hydrogenated 4,4′-diphenylmethane diisocyanate, 1,4-cyclohexane diisocyanate, methylcyclohexylene diisocyanate, isophorone diisocyanate, and norbornane diisocyanate.

Examples of the aromatic diisocyanates include 4,4′-diphenylmethane diisocyanate, xylylene diisocyanate, toluene diisocyanate, and naphthalene diisocyanate.

Examples of the diol compound include ethylene glycol, diethylene glycol, triethylene glycol, 1,2-propanediol, 1,3-propanediol, 1,4-butanediol, neopentyl glycol, 2-butene-1,4-diol, 1,5-pentanediol, 2-pentene-1,5-diol, 1,6-hexanediol, 1,4-cyclohexanedimethanol, dipropylene glycol, 1,4-benzenediol, polyethylene glycol, polypropylene glycol, and polytetramethylene glycol.

Examples of the bisphenol compound include bisphenol A, hydrogenated bisphenol A, bisphenol A-ethylene oxide adducts (e.g., polyoxyethylene (2,2)-2,2-bis(4-hydroxyphenyl)propane), and bisphenol A propylene oxide adducts.

### (Aqueous Medium)

The aqueous medium contained in the ink is a medium containing water. The aqueous medium may function as a solvent or function as a dispersion medium. Specific examples of the aqueous medium include water and an aqueous medium containing a water-soluble organic solvent.

### (Water)

The water has a percentage content in the ink of preferably at least 25.0% by mass and no greater than 80.0% by mass, and more preferably at least 40.0% by mass and no greater than 70.0% by mass.

### (Water-Soluble Organic Solvent)

Examples of the water-soluble organic solvent in the ink include glycol compounds, glycol ether compounds, lactam compounds, nitrogen-containing compounds, acetate compounds, thiodiglycol, glycerin, and dimethyl sulfoxide.

Examples of the glycol compounds include ethylene glycol, 1,3-propanediol, propylene glycol, 1,2-pentanediol, 1,5-pentanediol, 1,2-octanediol, 1,8-octanediol, 3-methyl-1,3-butanediol, 3-methyl-1,5-pentanediol, diethylene glycol, triethylene glycol, and tetraethylene glycol.

Examples of the glycol ether compounds include diethylene glycol diethyl ether, diethylene glycol monobutyl ether, ethylene glycol monomethyl ether, ethylene glycol monobutyl ether, diethylene glycol monomethyl ether, diethylene glycol monoethyl ether, diethylene glycol diethyl ether, dipropylene glycol methyl ether, triethylene glycol monomethyl ether (methyl triglycol), triethylene glycol monoethyl ether, triethylene glycol monobutyl ether, and propylene glycol monomethyl ether.

Examples of the lactam compounds include 2-pyrrolidone and N-methyl-2-pyrrolidone.

Examples of the nitrogen-containing compounds include 1,3-dimethylimidazolidinone, formamide, and dimethyl formamide.

Examples of the acetate compounds include diethylene glycol monoethyl ether acetate.

The water-soluble organic solvent is preferably a glycol compound or a glycol ether compound, and more preferably propylene glycol, triethylene glycol monobutyl ether, dipropylene glycol methyl ether, or triethylene glycol monomethyl ether.

The water-soluble organic solvent has a percentage content in the ink of preferably at least 10.0% by mass and no greater than 50.0% by mass, and more preferably at least 25.0% by mass and no greater than 40.0% by mass.

### (Surfactant)

Preferably, the ink further contains a surfactant. The surfactant optimizes compatibility and dispersion stability of each component contained in the ink.

Furthermore, the surfactant optimizes wettability of the ink to a recording medium. The surfactant in the ink is preferably a nonionic surfactant.

Examples of the nonionic surfactant in the ink include acetylene glycol surfactants (surfactants containing an acetylene glycol compound), silicone surfactants (surfactants containing a silicone compound), and fluorine surfactants (surfactants containing a fluoric resin or a fluorine-containing compound). Examples of the acetylene glycol surfactants include an ethylene oxide adduct of acetylene glycol and a propylene oxide adduct of acetylene glycol.

The ink preferably contains a silicone surfactant.

The surfactant has a percentage content in the ink of preferably at least 0.01% by mass and no greater than 1.00% by mass, and more preferably at least 0.02% by mass and no greater than 0.10% by mass.

### (Other Components)

The ink may further contain any known additive (e.g., any of a solution stabilizer, an anti-drying agent, an antioxidant, a viscosity modifier, a pH adjuster, and an antifungal agent) as necessary.

### (Ink Production Method)

The ink can be produced for example by uniformly mixing a pigment dispersion containing the pigment, a dispersion containing the anionic urethane resin particles, and other components (e.g., water and the surfactant) added as necessary using a stirrer. In ink production, uniform mixing of each component may be followed by removal of foreign matter and coarse particles using a filter (e.g., a filter with a pore diameter of no greater than 5 μm).

### (Pigment Dispersion)

The pigment dispersion is a dispersion containing the pigment. Preferably, the pigment dispersion further contains the pigment coating resin. The dispersion medium of the pigment dispersion is preferably water.

The pigment has a percentage content in the pigment dispersion of preferably at least 5.0% by mass and no greater than 25.0% by mass, and more preferably at least 10.0% by mass and no greater than 20.0% by mass. The pigment coating resin has a percentage content in the pigment dispersion of preferably at least 1.0% by mass and no greater than 10.0% by mass, and more preferably at least 2.0% by mass and no greater than 6.0% by mass.

The pigment dispersion can be prepared by wet dispersion of the pigment, the pigment coating resin, a dispersion medium (e.g., water), and a component (e.g., the surfactant) added as necessary using a media type wet disperser. Wet dispersion using a media type wet disperser can use small-diameter beads (e.g., beads with a D₅₀ of at least 0.5 mm and no greater than 1.0 mm) as a medium, for example. The material of the beads is not particularly limited and is preferably a hard material (e.g., glass or zirconia).

### (Preferable Composition)

The ink preferably has any of Compositions 1 to 4 indicated below in Table 1 and Compositions 5 to 8 indicated below in Table 2. Note that “Ratio” below in Tables 1 and 2 indicates a preferable numerical range for percentage content [% by mass]. For example, “3.5-4.1” being a ratio of the cyan pigment in Composition 1 indicates that at least 3.5% by mass and no greater than 4.1% by mass of the cyan pigment is contained. “e-1” indicates an anionic urethane resin particles with a D₅₀ of at least 55.0 nm and no greater than 68.0 nm. “e-2” indicates an anionic urethane resin particles with a D₅₀ of at least 9.0 nm and no greater than 11.0 nm. “e-3” indicates an anionic urethane resin particles with a D₅₀ of at least 36.0 nm and no greater than 44.0 nm. “DPGME” indicates dipropylene glycol methyl ether.

TABLE 1

| Composition | | | 1 | 2 | 3 | 4 |
|---|---|---|---|---|---|---|
| Ratio | Pigment | Cyan pigment | 3.5-4.1 | 3.5-4.1 | 3.5-4.1 | 3.5-4.1 |
| [%] | | Yellow pigment | — | — | — | — |
| | Pigment coating resin | | 1.2-1.4 | 1.2-1.4 | 1.2-1.4 | 1.2-1.4 |
| | Anionic | e-1 | 2.7-.3.3 | — | — | 3.4-4.6 |
| | urethane resin | e-2 | — | 2.7-.3.3 | — | — |
| | particles | e-3 | — | — | 2.7-.3.3 | — |

| | | | | |
|---|---|---|---|---|
| Propylene glycol | 22.6-27.5 | 22.6-27.5 | 22.6-27.5 | 22.6-27.5 |
| Butyl triglycol | 7.2-8.8 | 7.2-8.8 | 7.2-8.8 | 7.2-8.8 |
| DPGME | — | — | — | — |
| Methyl triglycol | — | — | — | — |
| Surfactant | 0.03-0.05 | 0.03-0.05 | 0.03-0.05 | 0.03-0.05 |
| Ion exchange water | Rest | Rest | Rest | Rest |
| Total | 100 | 100 | 100 | 100 |

TABLE 2

| Composition | | | 5 | 6 | 7 | 8 |
|---|---|---|---|---|---|---|
| Ratio | Pigment | Cyan pigment | 3.4-4.1 | 3.4-4.1 | 3.4-4.1 | — |
| [%] | | Yellow pigment | — | — | — | 3.4-4.1 |
| | Pigment coating resin | | 1.1-1.4 | 1.1-1.4 | 1.1-1.4 | 1.1-1.4 |
| | Anionic | e-1 | 4.5-5.5 | 2.7-.3.3 | 2.7-.3.3 | 2.7-.3.3 |
| | urethane resin | e-2 | — | — | — | — |
| | particles | e-3 | — | — | — | — |

| | | | | |
|---|---|---|---|---|
| Propylene glycol | 22.6-27.5 | 22.6-27.5 | 22.6-27.5 | 22.6-27.5 |
| Butyl triglycol | 7.2-8.8 | — | — | 7.2-8.8 |
| DPGME | — | 7.2-8.8 | — | — |
| Methyl triglycol | — | — | 7.2-8.8 | — |
| Surfactant | 0.03-0.05 | 0.03-0.05 | 0.03-0.05 | 0.03-0.05 |
| Ion exchange water | Rest | Rest | Rest | Rest |
| Total | 100 | 100 | 100 | 100 |

### [Pretreatment Liquid]

The pretreatment liquid contains nonionic urethane resin particles, (meth)acrylic resin particles, and polyester resin particles. Preferably, the pretreatment liquid further contains an aqueous medium.

### (Nonionic Urethane Resin Particles)

The nonionic urethane resin particles contain a nonionic urethane resin. The nonionic urethane resin has a percentage content in the nonionic urethane resin particles of preferably at least 80% by mass, more preferably at least 90% by mass, and further preferably 100% by mass. The nonionic urethane resin is a resin of urethane resins that is nether anionic nor cationic.

The nonionic urethane resin particles have a volume median diameter of preferably at least 50 nm and no greater than 1000 nm, and more preferably at least 70 nm and no greater than 180 nm. As a result of the volume median diameter of the nonionic urethane resin particles being set to at least 50 nm, preservation stability of the pretreatment liquid can be optimized. As a result of the volume median diameter of the nonionic urethane resin particles being set to no greater than 1000 nm, coatability of the pretreatment liquid can be optimized. Furthermore, ejection stability of the pretreatment liquid can be optimized in a case in which the pretreatment liquid is applied to a recording medium by ink jetting.

The nonionic urethane resin particles has a percentage content in the pretreatment liquid of preferably at least 2.0% by mass and no greater than 15.0% by mass, and more preferably at least 3.0% by mass and no greater than 5.0% by mass. As a result of the percentage content of the nonionic urethane resin particles being set to at least 2.0% by mass, adhesion of an image formed with the ink set of the present disclosure to a recording medium can be further optimized. As a result of the percentage content of the nonionic urethane resin particles being set to no greater than 12.0% by mass, coatability of the pretreatment liquid can be optimized. In addition, ejection stability of the pretreatment liquid can be optimized in a case in which the pretreatment liquid is applied to a recording medium by ink jetting.

### ((Meth)Acrylic Resin Particles)

The (meth)acrylic resin particles contain a (meth)acrylic resin. The (meth)acrylic resin has a percentage content in the (meth)acrylic resin particles of preferably at least 80% by mass, more preferably at least 90% by mass, and further preferably 100% by mass. The (meth)acrylic resin preferably has a hydroxyl group. The (meth)acrylic resin includes a repeating unit derived from at least one monomer of (meth)acrylic acid alkyl ester and (meth)acrylic acid. Preferably, the (meth)acrylic resin further includes a repeating unit derived from a (meth)acryl acid hydroxyalkyl ester (e.g., 2-hydroxyethyl (meth)acrylate).

The (meth)acrylic resin particles has a volume median diameter of preferably at least 30 nm and no greater than 200 nm, and more preferably at least 70 nm and no greater than 120 nm. As a result of the volume median diameter of the (meth)acrylic resin particles being set to at least 50 nm, preservation stability of the pretreatment liquid can be optimized. As a result of the volume median diameter of the (meth)acrylic resin particles being set to no greater than 200 nm, coatability of the pretreatment liquid can be optimized. Furthermore, ejection stability of the pretreatment liquid can be optimized in a case in which the pretreatment liquid is applied to a recording medium by ink jetting.

The (meth)acrylic resin particles have a percentage content in the pretreatment liquid of preferably at least 1.0% by mass and no greater than 10.0% by mass, and more preferably at least 2.0% by mass and no greater than 5.0% by mass. As a result of the percentage content of the (meth)acrylic resin particles being set to at least 1.0% by mass, adhesion of an image formed with the ink set of the present disclosure to a recording medium can be further optimized. As a result of the percentage content of the (meth)acrylic resin particles being set to no greater than 10.0% by mass, coatability of the pretreatment liquid can be optimized. In addition, ejection stability of the pretreatment liquid can be optimized in a case in which the pretreatment liquid is applied to a recording medium by ink jetting.

### (Polyester Resin Particles)

The polyester resin particles contain a polyester resin. The polyester resin has a percentage content in the polyester resin particles of preferably at least 80% by mass, more preferably at least 90% by mass, and further preferably 100% by mass.

The polyester resin can be obtained by condensation polymerization of at least one polyhydric alcohol and at least one polybasic carboxylic acid. Examples of the polyhydric alcohol for synthesis of the polyester resin include divalent alcohols (e.g., a diol compound and a bisphenol compound) and trivalent or more-valent alcohols. Examples of the polybasic carboxylic acid for synthesis of the polyester resin include divalent carboxylic acids and trivalent or more-valent carboxylic acids. Note that a polybasic carboxylic acid derivative (e.g., a polybasic carboxylic acid anhydride or a polybasic carboxylic acid halide) that can form an ester bond through condensation polymerization may be used in place of the polybasic carboxylic acid. Examples of the diol compound and the bisphenol compound for synthesis of the polyester resin include the same compounds listed as the examples of the diol compound and the bisphenol compounds for synthesis of the urethane resin, respectively.

Examples of the trivalent or more-valent alcohols include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane, and 1,3,5-trihydroxymethylbenzene.

Examples of the divalent carboxylic acids include maleic acid, fumaric acid, citraconic acid, itaconic acid, glutaconic acid, phthalic acid, isophthalic acid, terephthalic acid, cyclohexanedicarboxylic acid, adipic acid, sebacic acid, azelaic acid, malonic acid, succinic acid, alkyl succinic acids (specific examples include n-butylsuccinic acid, isobutylsuccinic acid, n-octylsuccinic acid, n-dodecylsuccinic acid, and isododecylsuccinic acid), and alkenyl succinic acids (specific example include n-butenylsuccinic acid, isobutenylsuccinic acid, n-octenylsuccinic acid, n-dodecenylsuccinic acid, and isododecenylsuccinic acid).

Examples of the trivalent or more-valent carboxylic acids include 1,2,4-benzenetricarboxylic acid (trimellitic acid), 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylene carboxyl propane, 1,2,4-cyclohexanetricarboxylic acid, tetra(methylenecarboxyl)methane, 1,2,7,8-octanetetracarboxylic acid, pyromellitic acid, and Empol trimer acid.

The polyester resin particles has a volume median diameter of preferably at least 50 nm and no greater than 200 nm, and more preferably at least 70 nm and no greater than 150 nm. As a result of the volume median diameter of the polyester resin particles being set to at least 50 nm, preservation stability of the pretreatment liquid can be optimized. As a result of the volume median diameter of the polyester resin particles being set to no greater than 200 nm, coatability of the pretreatment liquid can be optimized. In addition, ejection stability of the pretreatment liquid can be optimized in a case in which the pretreatment liquid is applied to a recording medium by ink jetting.

The polyester resin particles has a percentage content in the pretreatment liquid of preferably at least 1.0% by mass and no greater than 10.0% by mass, and more preferably at least 2.0% by mass and no greater than 5.0% by mass. As a result of the percentage content of the polyester resin particles being set to at least 1.0% by mass, ink wet spreadability can be further optimized. As a result of the percentage content of the polyester resin particles being set to no greater than 10.0% by mass, coatability of the pretreatment liquid can be optimized. In addition, ejection stability of the pretreatment liquid can be optimized in a case in which the pretreatment liquid is applied to a recording medium by ink jetting.

The total percentage content of the (meth)acrylic resin particles and the polyester resin particles in the pretreatment liquid is preferably at least 2.0% by mass and no greater than 15.0% by mass, and more preferably at least 3.0% by mass and no greater than 6.0% by mass. As a result of the total percentage content being set to at least 2.0% by mass, adhesion of an image formed with the ink set of the present disclosure to a recording medium can be further optimized and ink wet spreadability can be further optimized. As a result of the total percentage content being set to no greater than 15.0% by mass, coatability of the pretreatment liquid can be optimized. In addition, ejection stability of the pretreatment liquid can be optimized in a case in which the pretreatment liquid is applied to a recording medium by ink jetting.

### (Aqueous Medium)

The aqueous medium contained in the pretreatment liquid is a medium containing water. The aqueous medium may function as a solvent or function as a dispersion medium. Specific examples of the aqueous medium include water and an aqueous medium containing a water-soluble organic solvent.

### (Water)

The percentage content of the water in the pretreatment liquid is preferably at least 25.0% by mass and no greater than 80.0% by mass, and more preferably at least 40.0% by mass and no greater than 70.0% by mass.

### (Water-Soluble Organic Solvent)

No particular limitations are placed on the water-soluble organic solvent in the pretreatment liquid so long as it has compatibility with other components. As a result of the pretreatment liquid containing a water-soluble organic solvent, dryness of the pretreatment liquid can be optimized. Specific examples of the water-soluble organic solvent in the pretreatment liquid include methanol, ethanol, 1-propanol, 2-propanol, propylene glycol, acetone, tetrahydrofuran, and acetonitrile. Preferably, the water-soluble organic solvent in the pretreatment liquid is 2-propanol, propylene glycol, or methanol.

The water-soluble organic solvent has a percentage content in the pretreatment liquid of preferably at least 10.0% by mass and no greater than 50.0% by mass, and more preferably at least 20.0% by mass and no greater than 30.0% by mass.

### (Surfactant)

Preferably, the pretreatment liquid further contains a surfactant. The surfactant optimizes compatibility and dispersion stability of each component contained in the pretreatment liquid. Furthermore, the surfactant optimizes wettability of the pretreatment liquid to a recording medium. The surfactant in the pretreatment liquid is preferably a nonionic surfactant.

Examples of the nonionic surfactant in the pretreatment liquid includes the same compounds listed as the examples of the nonionic surfactant in the ink. Preferably, the pretreatment liquid further contains an acetylene glycol surfactant.

The surfactant has a percentage content in the pretreatment liquid of preferably at least 0.01% by mass and no greater than 1.00% by mass, and more preferably at least 0.02% by mass and no greater than 0.10% by mass.

### (Preferable Composition)

The pretreatment liquid preferably has any of Compositions 1 to 4 indicated below in Table 3, Compositions 5 to 8 indicated below in Table 4, and Compositions 9 to 11 indicated below in Table 5. Note that “a-1” below in Tables 3 to 5 indicates (meth)acrylic resin particles and polyester resin particles with a D₅₀ of at least 78.0 nm and no greater than 96.0 nm. “a-2” indicates (meth)acrylic resin particles and polyester resin particles with a D₅₀ of at least 81.0 nm and no greater than 99.0 nm. “a-3” indicates (meth)acrylic resin particles and polyester resin particles with a D₅₀ of at least 41.0 nm and no greater than 50.0 nm. “(b-1)” indicates nonionic urethane resin particles with a D₅₀ of at least 101.0 nm and no greater than 123.0 nm. “(b-2)” indicates nonionic urethane resin particles with a D₅₀ of at least 126.0 nm and no greater than 154.0 nm. “(b-3)” indicates nonionic urethane resin particles with a D₅₀ of at least 630.0 nm and no greater than 770.0 nm. “Ratio” indicates a preferable numerical range for percentage content (% by mass). As such, “4.6-5.6” being a ratio of resin particles “a-1” with Composition 1 indicates that a mixture of (meth)acrylic resin particles and polyester resin particles with a D₅₀ of at least 78.0 nm and no greater than 96.0 nm is contained at a percentage content of at least 4.6% by mass and no greater than 5.6% by mass.

TABLE 3

| Composition | | | 1 | 2 | 3 | 4 |
|---|---|---|---|---|---|---|
| Ratio | Resin | a-1 | 4.6-5.6 | 4.6-5.6 | 4.6-5.6 | — |
| [% by | parti- | a-2 | — | — | — | 6.8-8.2 |
| mass] | cles | a-3 | — | — | — | — |
| | | b-1 | 3.2-3.8 | — | — | 3.2-3.8 |
| | | b-2 | — | 10.1-12.6 | — | — |
| | | b-3 | — | — | 11.3-13.7 | — |

| | | | | |
|---|---|---|---|---|
| 2-Propanol | 22.5-27.5 | 22.5-27.5 | 22.5-27.5 | 22.5-27.5 |
| Propylene | — | — | — | — |
| glycol | | | | |
| Methanol | — | — | — | — |
| Surfactant | 0.03-0.05 | 0.03-0.05 | 0.03-0.05 | 0.03-0.05 |
| Ion exchange | Rest | Rest | Rest | Rest |
| water | | | | |
| Total | 100 | 100 | 100 | 100 |

TABLE 4

| Composition | | | 5 | 6 | 7 | 8 |
|---|---|---|---|---|---|---|
| Ratio | Resin | a-1 | — | 3.7-4.5 | 5.5-6.7 | 4.6-5.6 |
| [% by | parti- | a-2 | — | — | — | — |
| mass] | cles | a-3 | 5.7-6.9 | — | — | — |
| | | b-1 | 3.2-3.8 | 3.2-3.8 | 3.2-3.8 | 2.6-3.0 |
| | | b-2 | — | — | — | — |
| | | b-3 | — | — | — | — |

| | | | | |
|---|---|---|---|---|
| 2-Propanol | 22.5-27.5 | 22.5-27.5 | 22.5-27.5 | 22.5-27.5 |
| Propylene | — | — | — | — |
| glycol | | | | |
| Methanol | — | — | — | — |
| Surfactant | 0.03-0.05 | 0.03-0.05 | 0.03-0.05 | 0.03-0.05 |
| Ion exchange | Rest | Rest | Rest | Rest |
| water | | | | |
| Total | 100 | 100 | 100 | 100 |

TABLE 5

| Composition | | | 9 | 10 | 11 |
|---|---|---|---|---|---|
| Ratio | Resin particles | a-1 | 4.6-5.6 | 4.6-5.6 | 4.6-5.6 |
| [% by | | a-2 | — | — | — |
| mass] | | a-3 | — | — | — |
| | | b-1 | 3.8-4.6 | 3.2-3.8 | 3.2-3.8 |
| | | b-2 | — | — | — |
| | | b-3 | — | — | — |

| | | | |
|---|---|---|---|
| 2-Propanol | 22.5-27.5 | — | — |
| Propylene glycol | — | 22.5-27.5 | — |
| Methanol | — | — | 22.5-27.5 |
| Surfactant | 0.03-0.05 | 0.03-0.05 | 0.03-0.05 |
| Ion exchange water | Rest | Rest | Rest |
| Total | 100 | 100 | 100 |

### (Pretreatment Liquid Preparation Method)

The pretreatment liquid can be produced for example by uniformly mixing a dispersion containing the nonionic urethane resin particles, a dispersion containing the (meth)acrylic resin particles and the polyester resin particles, and other components (e.g., water, the water-soluble organic solvent, and the surfactant) added as necessary using a stiffer. In pretreatment liquid production, uniform mixing of each component may be followed by removal of foreign matter and coarse particles using a filter (e.g., a filter with a pore diameter of no greater than 5 in).

### Second Embodiment: Inkjet Recording Method

Next, an inkjet recording method according to a second embodiment of the present disclosure is described. The inkjet recording method of the present disclosure is an inkjet recording method for forming an image on a recording medium using the ink set according to the first embodiment, and includes a pretreatment process of applying the pretreatment liquid to the recording medium and an image formation process of forming an image by ejecting the ink toward the recording medium using a head after the pretreatment process. The inkjet recording method of the present disclosure uses the ink set according to the first embodiment. Therefore, an image with excellent adhesion to the recording medium can be formed with adequate ink wet spreadability ensured. The recording medium is preferably a non-permeable recording medium.

### [Pretreatment Process]

In the present process, the pretreatment liquid is applied to the recording medium. The method for applying the pretreatment liquid to the recording medium is not limited particularly, and may be bar coating, spraying, inkjet ejection, or immersion, for example. The method for applying the pretreatment liquid is preferably inkjet ejection.

In the present process, the pretreatment liquid may be applied to only an area of the surface of the recording medium where the ink is to be ejected or be applied to the entirety of the surface of the recording medium.

In the present process, the application amount of the pretreatment liquid can be for example such that the thickness of a liquid film of the pretreatment liquid to be formed on the recording medium is at least 2 μm and no greater than 10 μm.

During and after the present process, the recording medium may be heated for accelerating drying of the liquid film of the pretreatment liquid. Once the liquid film of the pretreatment liquid is dried, a pretreatment coating film containing the nonionic urethane resin particles, the (meth)acrylic resin particles, and the polyester resin particles as the main components is formed on the recording medium.

### [Ink Ejection Process]

In the present process, the ink is ejected toward the recording medium using a head to form a desired image after the pretreatment process. The head is not particularly limited, and examples of the head include a piezoelectric inkjet head and a thermal inkjet head. During and after the present process, the recording medium may be heated for accelerating ink drying.

### Examples

The following describes examples of the present disclosure. However, the present disclosure is not limited to the following examples.

In the examples, values for volume median diameter (D₅₀) are values measured using a dynamic light scattering type particle size distribution analyzer (“ZETASIZER (registered Japanese trademark) NANO ZS” produced by Malvern Instruments Ltd.). Note that in the measurement, a measurement target was diluted with ion exchange water as necessary for measurement.

### [Pretreatment Liquid Preparation]

Pretreatment liquids (P-1) to (P-14) were prepared according to the following method. First, commercially available dispersions for pretreatment liquid use used in pretreatment liquid preparation are indicated below.

### (Dispersions for Pretreatment Liquid Use)

A-1: “A-647GEX” produced by TAKAMATSU OIL&FAT CO., LTD.
A-2: “A-645GH” produced by TAKAMATSU OIL&FAT CO., LTD.
A-3: “A-615GE” produced by TAKAMATSU OIL&FAT CO., LTD.
A-4: “A-640” produced by TAKAMATSU OIL&FAT CO., LTD.
A-5: “JONCRYL (registered Japanese trademark) PDX-6102B” produced by BASF
B-1: “NS-310X-A” produced by TAKAMATSU OIL&FAT CO., LTD.
B-2: “SUPERFLEX (registered Japanese trademark) 500M” produced by DKS Co. Ltd.
B-3: “SUPERFLEX (registered Japanese trademark) E-2000” produced by DKS Co. Ltd.
B-4: “ETERNACOLL (registered Japanese trademark) UW-1527DF” produced by UBE Corporation

Details of each dispersion for pretreatment liquid use are shown below in Table 6.

TABLE 6

| | | Solid | |
|---|---|---|---|
| | | concentration | D₅₀ |
| | Resin particles | [% by mass] | [nm] |
| A-1 | (Meth)acrylic acid particles + Polyester resin particles | 20.4 | 86.8 |
| A-2 | (Meth)acrylic acid particles + Polyester resin particles | 30.0 | 90.2 |
| A-3 | (Meth)acrylic acid particles + Polyester resin particles | 25.3 | 45.7 |
| A-4 | Polyester resin particles | 24.8 | 14.1 |
| A-5 | (Meth)acrylic acid particles | 24.5 | 17.4 |
| B-1 | Nonionic urethane resin particles | 14.0 | 112.0 |
| B-2 | Nonionic urethane resin particles | 45.1 | 140.0 |
| B-3 | Nonionic urethane resin particles | 50.0 | 700.0 |
| B-4 | Anionic urethane resin particles | 29.8 | 61.5 |

The pretreatment liquids (P-1) to (P-14) were prepared by mixing the corresponding components as indicated below in Tables 7 and 8. “Surfactant” means an acetylene glycol surfactant (“SURFYNOL (registered Japanese trademark) 440”, product of Nissin Chemical Industry Co., Ltd., ethylene oxide adduct of acetylene glycol).

TABLE 7

| | | | P-1 | P-2 | P-3 | P-4 | P-5 | P-6 | P-7 |
|---|---|---|---|---|---|---|---|---|---|
| Composition | Dispersion | A-1 | 25.0 | 25.0 | 25.0 | 25.0 | — | — | — |
| [% by mass] | | A-2 | — | — | — | — | 25.0 | — | — |
| | | A-3 | — | — | — | — | — | 25.0 | — |
| | | A-4 | — | — | — | — | — | — | 25.0 |
| | | A-5 | — | — | — | — | — | — | — |
| | | B-1 | 25.0 | — | — | — | 25.0 | 25.0 | 25.0 |
| | | B-2 | — | 25.0 | — | — | — | — | — |
| | | B-3 | — | — | 25.0 | — | — | — | — |
| | | B-4 | — | — | — | 25.0 | — | — | — |

| | | | | | | | |
|---|---|---|---|---|---|---|---|
| 2-Propanol | 25.0 | 25.0 | 25.0 | 25.0 | 25.0 | 25.0 | 25.0 |
| Propylene glycol | — | — | — | — | — | — | — |
| Methanol | — | — | — | — | — | — | — |
| Surfactant | 0.04 | 0.04 | 0.04 | 0.04 | 0.04 | 0.04 | 0.04 |
| Ion exchange water | Rest | Rest | Rest | Rest | Rest | Rest | Rest |
| Total | 100 | 100 | 100 | 100 | 100 | 100 | 100 |

TABLE 8

| | | | P-8 | P-9 | P-10 | P-11 | P-12 | P-13 | P-14 |
|---|---|---|---|---|---|---|---|---|---|
| Composition | Dispersion | A-1 | 20.0 | 30.0 | 25.0 | 25.0 | 25.0 | 25.0 | — |
| [% by mass] | | A-2 | — | — | — | — | — | — | — |
| | | A-3 | — | — | — | — | — | — | — |
| | | A-4 | — | — | — | — | — | — | — |
| | | A-5 | — | — | — | — | — | — | 25.0 |
| | | B-1 | 25.0 | 25.0 | 20.0 | 30.0 | 25.0 | 25.0 | 25.0 |
| | | B-2 | — | — | — | — | — | — | — |
| | | B-3 | — | — | — | — | — | — | — |
| | | B-4 | — | — | — | — | — | — | — |

| | | | | | | | |
|---|---|---|---|---|---|---|---|
| 2-Propanol | 25.0 | 25.0 | 25.0 | 25.0 | — | — | 25.0 |
| Propylene glycol | — | — | — | — | 25.0 | — | — |
| Methanol | — | — | — | — | — | 25.0 | — |
| Surfactant | 0.04 | 0.04 | 0.04 | 0.04 | 0.04 | 0.04 | 0.04 |
| Ion exchange water | Rest | Rest | Rest | Rest | Rest | Rest | Rest |
| Total | 100 | 100 | 100 | 100 | 100 | 100 | 100 |

### [Pigment Dispersion Preparation]

Pigment dispersions (C) and (Y) for ink preparation use were prepared. The components contained in each pigment dispersion and their amounts are shown below in Table 9.

TABLE 9

| | | Pigment dispersion (C) | Pigment dispersion (Y) |
|---|---|---|---|
| Percentage | Water | 80 | 80 |
| content | Resin A-Na | 5 | 5 |
| [% by | Cyan pigment | 15 | — |
| mass] | Yellow pigment | — | 15 |
| | Total | 100 | 100 |

In Table 9, “Resin A-Na” is a resin A (pigment coating resin) neutralized with sodium hydroxide (NaOH). “Cyan pigment” and “Yellow pigment” are as follows. Cyan pigment: “HELIOGEN (registered Japanese trademark) BLUE D7088” produced by BASF Corporation
Yellow pigment: “PALCOHOL YELLOW D1115J” produced by BASF Corporation

### [Preparation of Resin A]

According to the following method, the resin A used for obtaining the “resin A-Na” in Table 9 was prepared. In detail, a stirrer, a nitrogen inlet tube, a condenser, and a dropping funnel were set at a four-necked flask. Next, 100 parts by mass of isopropyl alcohol and 300 parts by mass of methyl ethyl ketone were added into the flask. Heat reflux at 70° C. was performed on the flask contents under nitrogen bubbling.

Next a solution L1 was prepared. In detail, the solution L1 being a monomer solution was obtained by mixing 40.0 parts by mass of styrene, 10.0 parts by mass of methacrylic acid, 40.0 parts by mass of methyl methacrylate, 10.0 parts by mass of butyl acrylate, and 0.4 parts by mass of azobisisobutyronitrile (AIBN, polymerization initiator). The solution L1 was dripped into the flask over 2 hours in a state in which heat reflux at 70° C. was performed on the flask contents. After the dripping, heat reflux at 70° C. was performed on the flask contents for additional 6 hours.

Next, a solution L2 was prepared. In detail, the solution L2 was obtained by mixing 0.2 parts by mass of AIBN and 150.0 parts by mass of methyl ethyl ketone. The solution L2 was dripped into the flask over 15 minutes. After the dripping, heat reflux at 70° C. was performed on the flask contents for additional 5 hours. In the manner described above, the resin A (styrene-(meth)acrylic resin) was obtained. The resultant resin A had a mass average molecular weight (Mw) of 20,000 and an acid value of 100 mgKOH/g.

Here, the mass average molecular weight Mw of the resin A was measured under the following conditions using a gel filtration chromatography (“HLC-8020GPC”, product of Tosoh Corporation).
Columns: “TSKgel Super Multipore HZ-H” produced by Tosoh Corporation (semi-micro columns with 4.6 mm I.D.×15 cm).
Number of columns: 3
Eluent: tetrahydrofuran
Flow rate: 0.35 mL/min.
Sample injection amount: 10 μL
Measurement temperature: 40° C.
Detector: IR detector

A calibration curves was plotted using n-propylbenzene and seven selected TSKgel Standard Polystyrenes. The TSKgel Standard Polystyrenes were F-40, F-20, F-4, F-1, A-5000, A-2500, and A-1000 each produced by Tosoh Corporation.

Furthermore, the acid value of the resin A was measured by a method in accordance with the Japanese Industrial Standards (JIS) K0070-1992 (Test methods for acid value, saponification value, ester value, iodine value, hydroxyl value and unsaponifiable matter of chemical products).

### (Pigment Dispersion (C))

An aqueous solution of sodium hydroxide in an amount necessary to neutralize the resin A was added to the resin A while the resin A was heated in a warm bath at 70° C. More specifically, an aqueous solution of sodium hydroxide with a mass of 1.1 times the neutralization equivalent was added to the resin A. In the manner described above, an aqueous solution of the resin A (resin A-Na) neutralized with sodium hydroxide was obtained. The aqueous solution of the resin A-Na had a pH of 8.

The vessel of a media type wet disperser (“DYNO (registered Japanese trademark) MILL”, product of Willy A. Bachofen AG (WAB)) was charged with 5 parts by mass of an aqueous solution containing the resin A-Na, 15 parts by mass of a cyan pigment, and water in the mixing ratio shown in Table 9, so that the total amount was adjusted to 100 parts by mass. Note that the water was added so that the mass of water including the mass of water contained in the aqueous solution of sodium hydroxide used for neutralizing the resin A and the mass of water produced by the neutralization reaction was 80 parts by mass.

Next, a medium (zirconia beads with a diameter of 1.0 mm) was charged into the vessel so that the filling rate of the medium was 70% by volume to the capacity of the vessel. The vessel contents were dispersed using the media type wet disperser. In the manner described above, a pigment dispersion (C) being a pigment dispersion for cyan ink use was obtained.

The pigment dispersion (C) was diluted 300 times with water to obtain a dilution. The dilution was measured using a dynamic light scattering type particle size distribution analyzer (“ZETASIZER (registered Japanese trademark) NANO ZS”, product of Malvern Instruments Ltd.) to obtain the volume median diameter (D₅₀) of the pigment particles contained in the pigment dispersion (C). Thereafter, it was confirmed that pigment particles with a volume median diameter in the range of 70 nm to 130 nm were dispersed in the pigment dispersion (C).

### (Pigment Dispersion (Y))

A pigment dispersion (Y) was prepared according to the same method as that for preparing the pigment dispersion (C) in all aspects other than that the types and amounts of the components used were as shown below in Table 9. The pigment dispersion (Y) was a pigment dispersion for yellow ink use.

### [Ink Preparation]

According to the following method, ink (I-9) was prepared. Commercially available dispersions for ink use used in preparation of each ink were indicated below.

### (Dispersions for Ink Use)

E-1: “ETERNACOLL (registered Japanese trademark) UW-1527DF” produced by UBE Corporation
E-2: “SUPERFLEX (registered Japanese trademark) 170” produced by DKS Co. Ltd.
E-3: “SUPERFLEX (registered Japanese trademark) 210” produced by DKS Co. Ltd.
E-4: “NS-310X” produced by TAKAMATSU OIL&FAT CO., LTD.

Details of each dispersion for ink use are shown below in Table 10.

TABLE 10

| | | Solid concentration | |
|---|---|---|---|
| | Resin particles | [% by mass] | D₅₀ [nm] |
| E-1 | Anionic urethane resin particles | 29.8 | 61.5 |
| E-2 | Anionic urethane resin particles | 33.0 | 10.0 |
| E-3 | Anionic urethane resin particles | 35.0 | 40.0 |
| E-4 | Nonionic urethane resin particles | 14.0 | 112.0 |

### (Ink (I-1))

A beaker was charged with 25.0 parts by mass of the pigment dispersion (C) (containing 3.75 parts by mass of the cyan pigment and 1.25 parts by mass of the resin A-Na), 10.1 parts by mass of the dispersion (E-1) for ink use (containing 3.0 parts by mass of the resin particles), 25.0 parts by mass of propylene glycol, 8.0 parts by mass of triethylene glycol monobutyl ether (butyl triglycol), 0.04 parts by mass of a silicone surfactant (“SILFACE (registered Japanese trademark) SAG 503A”, product of Nissin Chemical Industry Co., Ltd., polyether modified siloxane compound), and water. The amount of the water added was such that the total amount of the resultant mixture in the beaker was 100 parts by mass. The beaker contents were mixed using a stirrer (“THREE-ONE MOTOR BL-600”, product of Shinto Scientific Co., Ltd.) at a rotational speed of 400 rpm to obtain a mixed liquid. The mixed liquid was filtered using a filter (pore size 5 μm) to remove foreign matter and coarse particles contained in the mixed liquid. In the manner described above, an ink (I-1) being a cyan ink was obtained.

### (Inks (I-2) to (I-9))

Inks (I-2) to (I-8) each being a cyan ink and an ink (I-9) being a yellow ink were prepared according to the same method as that for preparing the ink (I-1) in all aspects other than change of materials used to those shown below in Table 11.

Abbreviations used below in Table 11 were explained below.
%: percentage by mass
Surfactant: silicon surfactant (SILFACE (registered Japanese trademark) SAG 503A”, product of Nissin Chemical Industry Co., Ltd., polyether modified siloxane compound) DPGME: dipropylene glycol methyl ether

TABLE 11

| | | | I-1 | I-2 | I-3 | I-4 | I-5 | I-6 | I-7 | I-8 | I-9 |
|---|---|---|---|---|---|---|---|---|---|---|---|
| Composition | Pigment | C | 5.0 | 5.0 | 5.0 | 5.0 | 5.0 | 5.0 | 5.0 | 5.0 | — |
| [%] | dispersion | Y | — | — | — | — | — | — | — | — | 5.0 |
| | Resin | E-1 | 3.0 | — | — | — | 4.0 | 5.0 | 3.0 | 3.0 | 3.0 |
| | particles | E-2 | — | 3.0 | — | — | — | — | — | — | — |
| | | E-3 | — | — | 3.0 | — | — | — | — | — | — |
| | | E-4 | — | — | — | 3.0 | — | — | — | — | — |

| | | | | | | | | | |
|---|---|---|---|---|---|---|---|---|---|
| Propylene glycol | 25.0 | 25.0 | 25.0 | 25.0 | 25.0 | 25.0 | 25.0 | 25.0 | 25.0 |
| Butyl triglycol | 8.0 | 8.0 | 8.0 | 8.0 | 8.0 | 8.0 | — | — | 8.0 |
| DPGME | — | — | — | — | — | — | 8.0 | — | — |
| Methyl triglycol | — | — | — | — | — | — | — | 8.0 | — |
| Surfactant | 0.04 | 0.04 | 0.04 | 0.04 | 0.04 | 0.04 | 0.04 | 0.04 | 0.04 |
| Ion exchange water | Rest | Rest | Rest | Rest | Rest | Rest | Rest | Rest | Rest |
| Total | 100 | 100 | 100 | 100 | 100 | 100 | 100 | 100 | 100 |

### <Ink Set Preparation>

Ink sets of Examples 1 to 22 and Comparative Examples 1 to 9 were prepared by combining the inks and the pretreatment liquids as shown below in Table 12.

### <Evaluation>

With respect to each of the ink sets, ink wet spreadability and adhesion of formed images were evaluated according to the following methods. Evaluation results are shown below in Table 12.

### [Evaluation Apparatus]

As an evaluation apparatus, a line head inkjet recording apparatus (testing apparatus produced by KYOCERA Document Solutions Japan Inc.) was used. The evaluation apparatus included a conveyor table and four recording heads (“KJ4B-HD06MHG-STDV”, product of KYOCERA Corporation) arranged in parallel in a printing direction. The recording heads included a recording head for black ink use, a recording head for cyan ink use, a recording head for magenta ink use, and a recording head for yellow ink use arranged in the stated order from upstream to downstream in the printing direction. Each recording head included 2656 nozzles. The intervals between the recording heads were set to 55 cm. The recording heads were set to have an application voltage of 21 V, a drive frequency of 20 kHz, an ejection droplet amount of 3 pL, a head temperature of 32° C., and a resolution of 600 dpi, and the number of times of pre-ejection flushing was set to 1000 times. The conveyor table was pre-warmed to 40° C. in image formation using the evaluation apparatus. Furthermore, the image conveyance speed was set to 30 m/min. in image formation using the evaluation apparatus. An OPP film (“TORAYFAN (registered Japanese trademark), product of Toray Industries, Inc.) was used as a recording medium.

### [Pretreatment]

The pretreatment liquid of the ink set was applied onto the recording medium using a bar coater (“#01” available at AS ONE Corporation). The application amount of the pretreatment liquid was such that the resultant liquid film had a thickness of 6 μm. Thereafter, the recording medium was dried at 80° C. for 2 minutes. Through the above, the pretreatment coating film was formed on the recording medium. Through the above, the recording medium was pretreated to be a pretreated recording medium.

### [Ink Wet Spreadability]

Using the evaluation apparatus, a stripe image (also referred to below as evaluation image) with 14 parallel thin lines (1-dot lines) was formed on the pretreated recording medium. Each film with the evaluation image formed thereon was dried at 80° C. for 120 seconds using a dryer (“ON-300SB” available at AS ONE Corporation, constant-temperature dryer). The line width of each fine line of the dried evaluation image was measured. The average value (average line width) of the measured line widths was taken to be an evaluation value for ink wet spreadability. It is determined that the larger the evaluation value is, the more excellent ink wet spreadability is. Ink wet spreadability was evaluated according to the following criteria.

### (Evaluation Criteria of Ink Wet Spreadability)

A (good): evaluation value of at least 70 μm
B (poor): evaluation value of at least 50 μm and less than 70 μm
C (very poor): evaluation value of less than 50 μm

### [Base Material Adhesion]

Lattice-like (grid-like) incisions of 6 vertical lines and 6 horizontal lines were made at 1-mm intervals in the pretreatment coating film on the pretreated recording medium to form 25 square-shaped cells of 1 mm on each side. Adhesive tape (“CELLOTAPE (registered Japanese trademark) CT-24”, product of Nichiban Co., Ltd.) was attached onto the pretreatment coating film with the incisions formed therein, and peeled off from the pretreatment coating film at an angle of approximately 60 degrees (peeling). The peeling of the adhesive tape was carried out at a speed at which the time from a peeling start to a peeling end was 1 second. After the peeling, the recording medium was observed to count the number of peeled cells out of the 25 cells formed in the pretreatment coating film. Base material adhesion was evaluated according to the following criteria.

### (Evaluation Criteria of Base Material Adhesion)

A (very good): No cells were peeled.
B (good): The number of peeled cells was 1 to 3.
C (poor): The number of peeled cells was 4 to 6.
D (very poor): The number of peeled cells was 7 or more.

### [Coating Film Adhesion]

A solid image (40 mm×40 mm, printing rate 100%) was formed on a recording medium after the pretreatment process. The film after the image formation process was dried at 80° C. for 120 seconds using the aforementioned dryer. Lattice-like (grid-like) incisions of 6 vertical lines and 6 horizontal lines were made at 1-mm intervals in the solid image on the dried recording medium to form 25 square-shaped cells of 1 mm on each side. Adhesive tape (“CELLOTAPE (registered Japanese trademark) CT-24”, product of Nichiban Co., Ltd.) was attached onto the solid image with the incisions formed therein, and peeled off from the solid image at an angle of approximately 60 degrees (peeling). The peeling of the adhesive tape was carried out at a speed at which the time from a peeling start to a peeling end was 1 second. After the peeling, the recording medium was observed to count the number of peeled cells out of the 25 cells formed in the solid image. Coating film adhesion was evaluated according to the following criteria.

### (Evaluation Criteria of Coating Film Adhesion)

A (very good): No cells were peeled.
B (good): The number of peeled cells was 1 to 3.
C (poor): The number of peeled cells was 4 to 6.
D (very poor): The number of peeled cells was 7 or more.

TABLE 12

| | Ink set | | Evaluation | | |
|---|---|---|---|---|---|
| | | Pretreatment | Ink wet | Base material | Coating film |
| | Ink | liquid | spreadability | adhesion | adhesion |
| Example 1 | I-1 | P-1 | A | A | A |
| Example 2 | I-2 | P-1 | A | A | A |
| Example 3 | I-3 | P-1 | A | A | A |
| Example 4 | I-1 | P-2 | A | A | A |
| Example 5 | I-2 | P-2 | A | A | A |
| Example 6 | I-3 | P-2 | A | A | A |
| Example 7 | I-1 | P-3 | A | A | A |
| Example 8 | I-2 | P-3 | A | A | A |
| Example 9 | I-3 | P-3 | A | A | A |
| Example 10 | I-1 | P-5 | A | A | A |
| Example 11 | I-1 | P-6 | A | A | A |
| Example 12 | I-1 | P-8 | A | A | A |
| Example 13 | I-1 | P-9 | A | A | A |
| Example 14 | I-1 | P-10 | A | A | A |
| Example 15 | I-1 | P-11 | A | A | A |
| Example 16 | I-1 | P-12 | A | A | A |
| Example 17 | I-1 | P-13 | A | A | A |
| Example 18 | I-5 | P-1 | A | A | A |
| Example 19 | I-6 | P-1 | A | A | A |
| Example 20 | I-7 | P-1 | A | A | A |
| Example 21 | I-8 | P-1 | A | A | A |
| Example 22 | I-9 | P-1 | A | A | A |
| Comparative | I-4 | P-2 | A | A | C |
| Example 1 | | | | | |
| Comparative | I-4 | P-1 | A | A | C |
| Example 2 | | | | | |
| Comparative | I-4 | P-3 | A | A | C |
| Example 3 | | | | | |
| Comparative | I-1 | P-4 | A | C | C |
| Example 4 | | | | | |
| Comparative | I-2 | P-4 | A | C | C |
| Example 5 | | | | | |
| Comparative | I-3 | P-4 | A | D | D |
| Example 6 | | | | | |
| Comparative | I-4 | P-4 | A | D | D |
| Example 7 | | | | | |
| Comparative | I-1 | P-7 | A | C | C |
| Example 8 | | | | | |
| Comparative | I-1 | P-14 | B | A | C |
| Example 9 | | | | | |

As shown in Tables 6 to 12, the ink sets of Examples 1 to 22 each included an ink and a pretreatment liquid. The ink contained a pigment, anionic urethane resin particles, and an aqueous medium. The pretreatment liquid contained nonionic urethane resin particles, (meth)acrylic resin particles, and polyester resin particles. With any of the ink sets of Examples 1 to 22, images with excellent adhesion to the recording medium were formed while adequate ink wet spreadability was ensured.

By contrast, the ink sets of Comparative Examples 1 to 9, which did not have the above features, were poor in at least one of ink wet spreadability, base material adhesion, and coating film adhesion.

In detail, each ink of the ink sets of Comparative Examples 1 to 3 contained nonionic urethane resin particles rather than anionic urethane resin particles. Images formed with an ink containing nonionic urethane resin particles have been found to be insufficient in adhesion to the pretreatment coating film that is hydrophilic. As a result, the ink sets of Comparative Examples 1 to 3 were poor in coating film adhesion.

The pretreatment liquid of each of the ink sets of Comparative Examples 4 to 6 contained anionic urethane resin particles rather than nonionic urethane resin particles. Pretreatment coating films containing no nonionic urethane resin particles have found to be insufficient in adhesion to a non-polar recording medium such as an OPP film. As a result, the ink sets of Comparative Examples 4 to 6 were poor in base material adhesion.

In the ink set of Comparative Example 7, the ink contained no anionic urethane resin particles and the pretreatment liquid contained no nonionic urethane resin particles. As a result, the ink sets of Comparative Examples 7 was poor in base material adhesion and coating film adhesion.

The pretreatment liquid of the ink set of Comparative Example 8 contained no (meth)acrylic resin particles. The pretreatment coating film containing no (meth)acrylic resin particles has been found to be insufficient in adhesion to a non-polar recording medium such as an OPP film. As a result, the ink set of Comparative Example 8 was poor in base material adhesion.

The pretreatment liquid of the ink set of Comparative Example 9 contained no polyester resin particles. The pretreatment coating film containing no polyester resin particles has been found to be less hydrophilic and difficult for inks to wet and spread. As a result, the ink set of Comparative Example 9 was poor in ink wet spreadability. Furthermore, the ink set of Comparative Example 9 was also poor in coating film adhesion.

What is claimed is:

1. An ink set comprising: an inkjet ink; and a pretreatment liquid, wherein
the inkjet ink contains a pigment, anionic urethane resin particles, and an aqueous medium, and
the pretreatment liquid contains nonionic urethane resin particles, (meth)acrylic resin particles, and polyester resin particles.

2. The ink set according to claim 1, wherein
in the pretreatment liquid, the nonionic urethane resin particles have a percentage content of at least 2.0% by mass and no greater than 15.0% by mass,
the (meth)acrylic resin particles have a percentage content of at least 2.0% by mass and no greater than 10.0% by mass, and
the polyester resin particles have a percentage content of at least 2.0% by mass and no greater than 10.0% by mass.

3. The ink set according to claim 1, wherein
in the inkjet ink, the anionic urethane resin particles have a percentage content of at least 1.0% by mass and no greater than 12.0% by mass.

4. An inkjet recording method for forming an image on a recording medium with the ink set according to claim 1, comprising:
applying the pretreatment liquid to the recording medium; and
forming the image by ejecting the inkjet ink toward the recording medium using a head after the applying.

5. The inkjet recording method according to claim 4, wherein
the recording medium is a non-permeable recording medium.
